(19) United States
(12) Patent Application Publication
(10) Pub. No.: US 2018/0051884 A1
(43) Pub. Date: Feb. 22, 2018

(54) INJECTOR DEVICE AND METHOD FOR MANUFACTURING AN INJECTOR DEVICE

(71) Applicant: ANSALDO ENERGIA SWITZERLAND AG, Baden (CH)

(72) Inventors: Alexey STYTSENKO, Moscow (RU); Sergey MYLNIKOV, Moscow (RU); Igor BAIBUZENKO, Moscow (RU); Michael MAURER, Bad Säckingen (DE)

(73) Assignee: ANSALDO ENERGIA SWITZERLAND AG, Baden (CH)

(21) Appl. No.: 15/669,331

(22) Filed: Aug. 4, 2017

(30) Foreign Application Priority Data
Aug. 16, 2016 (RU) 2016133586

(51) Int. Cl. F23R 3/36; F02C 3/04; F02C 7/22

(52) U.S. Cl. CPC F23R 3/36; F02C 3/04; F05D 2230/31; F05D 2220/32; F02C 7/22

(57) ABSTRACT

An injector device is disclosed which includes an elongated body with a leading edge and a trailing edge, gas nozzles and oil nozzles, an oil supply duct housed within the elongated body and connected to the oil nozzles, and a gas supply duct housed within the elongated body and connected to the gas nozzles. The oil supply duct is connected to the gas supply duct only between one or more oil nozzles and one gas nozzles, and the gas supply duct is connected to the elongated body only via bridges.

### PRIORITY CLAIM

This application claims priority from Russian Patent Application No. 2016133586 filed on Aug. 16, 2016, the disclosure of which is incorporated by reference.

### TECHNICAL FIELD

The present invention relates to an injector device and a method for manufacturing an injector device. In particular, the injector device is for injecting a fuel in a combustion chamber of a gas turbine.

### BACKGROUND

Injector devices are known having an elongated body with a leading edge and a trailing edged having a lobed configuration and provided with nozzles for injection of air, gas fuel and oil fuel. The elongated body houses an oil supply duct and a gas supply duct fluidly connected to the nozzles. The oil supply duct and gas supply duct are connected to each other and are also connected to the elongated body, in order to be supported within the elongated body.

This configuration can cause internal stress in the injector device during operation, because of the thermal deformation of the oil supply duct, gas supply duct and elongated body. The stress can cause damages in the injector device and has to be counteracted.

### SUMMARY

An aspect of the invention includes providing and injector device that during operation undergoes reduced internal stress when compared with the existing injector devices.

Another aspect of the invention is to indicate a method for manufacturing an injection device that during operation undergoes reduced internal stress when compared with the existing injector devices.

These and further aspects are attained by providing an injector and a method in accordance with the accompanying claims.

### BRIEF DESCRIPTION OF THE DRAWINGS

Further characteristics and advantages will be more apparent from the description of a preferred but non-exclusive embodiment of the injector device and method, illustrated by way of non-limiting example in the accompanying drawings, in which:

FIGS. 1 and 2 show a side view and a perspective view of an injection device;

FIGS. 3 and 4 shows a longitudinal section and a cross section along line IV-IV of FIG. 3 of the injection device in an embodiment with lobed trailing edge;

FIG. 5 shows an injection structure that can be manufactured by selective laser melting and to be further worked to manufacture the injector device;

FIG. 6 shows the injection structure during further working for realizing the injector device;

FIG. 7 shows a different embodiment of the injector device;

FIG. 8 shows a cross section of the injection device in an embodiment with straight trailing edge;

FIG. 9 shows a cross section of the injection device in an embodiment with a zig-zag (triangular) trailing edge.

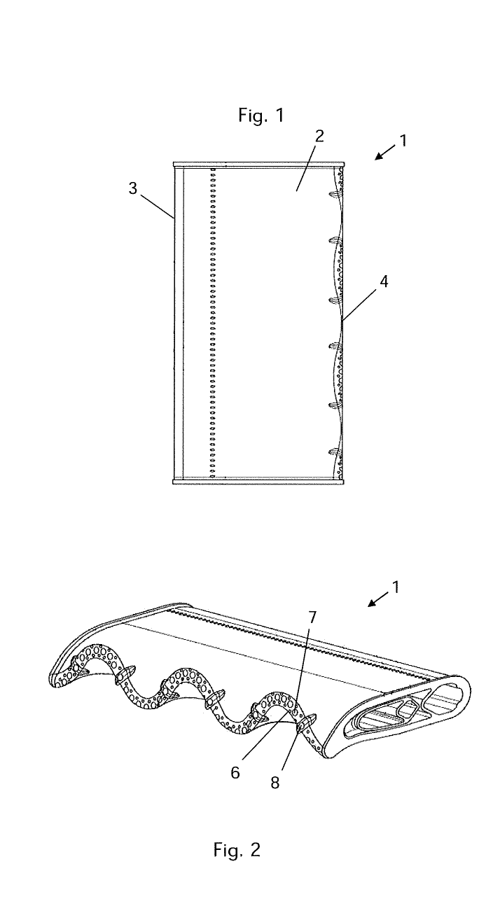

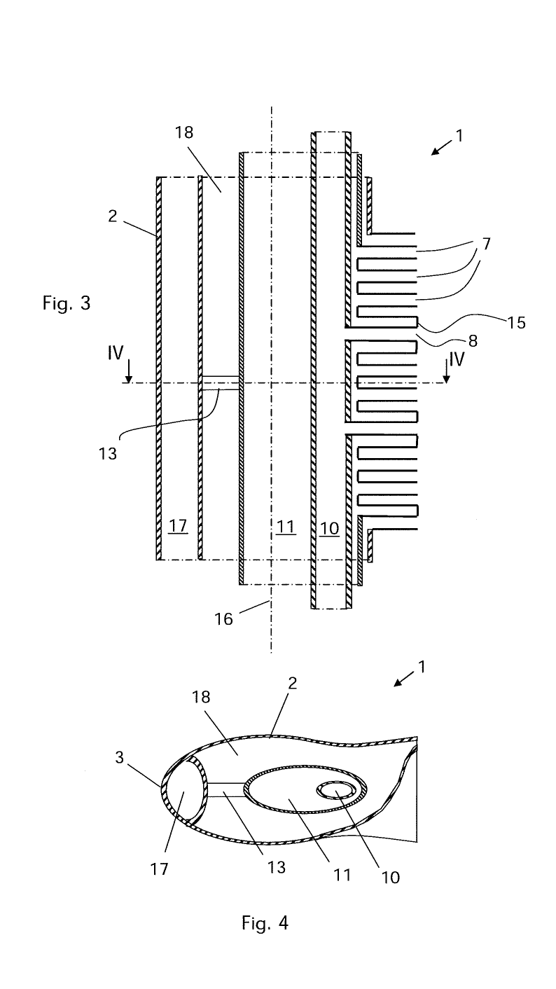

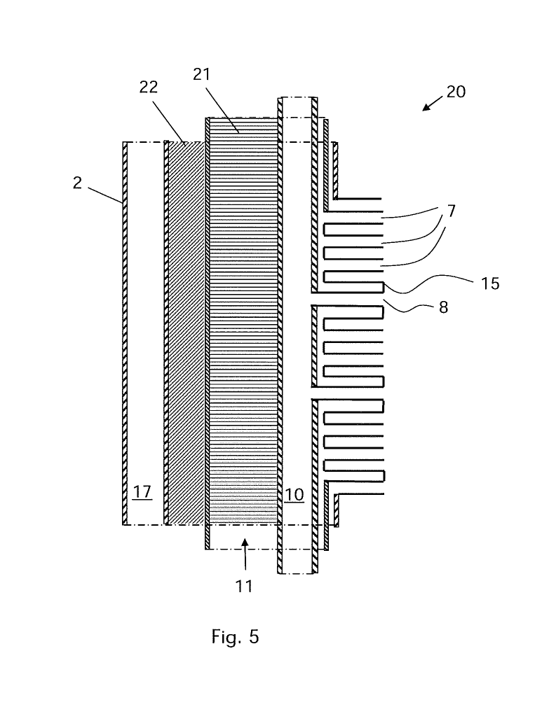

### DETAILED DESCRIPTION OF EXEMPLARY EMBODIMENTS

With reference to the figures, these show an injector device 1 for a burner of a gas turbine.

The injector device 1 comprises an elongated body 2 with a leading edge 3 and a trailing edge 4; the trailing edge 4 has a lobed configuration. Alternatively, the trailing edge can have a straight configuration, e.g. with vortex generators on the elongated body 2, or a zig-zag (triangular) configuration.

The injector device 1 further has air nozzles 6, gas nozzles 7 and oil nozzles 8, which are preferably located at the trailing edge, but they could also be located differently, e.g. the air nozzles 6 and/or gas nozzles 7 and/or oil nozzles 8 can be located on one or both sides of the elongated body in addition to or instead of the trailing edge 4.

Within the elongated body 2 there are provided an oil supply duct 10, which is connected to the oil nozzles 8, and a gas supply duct 11, which is connected to the gas nozzles 7.

Advantageously, the oil supply duct 10 is connected to the gas supply duct 11 only via a connection provided between the oil nozzles 8 and gas nozzles 7, and the gas supply duct 11 is connected to the elongated body 2 only via bridges 13.

For example, as shown in the figures, the connection between the oil supply duct 10 and the gas supply duct 11 is achieved via walls 15 extending between the nozzles 7, 8.

For example the bridges 13 connecting the gas supply duct 11 to the elongated body 2 are elongated elements, extending perpendicularly or substantially perpendicularly to the longitudinal axis 16 of the injection device 1.

The connection between the oil supply duct 10 and the gas supply duct 11 (e.g. the walls 15) preferably is at the terminal part of the nozzles 7, 8.

In one embodiment, the elongated body 2 can have a channel 17 at the leading edge 3, and the bridges 13 are provided only between the gas supply duct 11 and the channel 17.

Advantageously, the injector only has two bridges 13, each bridge being connected at one of the sides of the gas supply duct.

The operation of the injector device is apparent from that described and illustrated and is substantially the following.

This injector device is a component of a reheat burner. A gas turbine with reheat burner has a compressor for compressing air, a first burner for injecting fuel in the compressed air and generated hot gas, a high pressure turbine to partly expand the hot gas (but this high pressure turbine could also not be provided), a reheat burner to inject further fuel and possibly air into the hot gas, possibly partly expanded and a turbine, to expand the hot gas.

In particular, these injector devices transversally extend within a duct that carries the hot gas.

According to the operation mode of the gas turbine, oil fuel can be provided through the oil supply channel 10 to be injected via the nozzles 8 and/or gas fuel can be provided through the gas supply duct 11 to be injected via the nozzles 7; typically air is provided together with the oil fuel and/or gas fuel via the elongated body 2 (in particular through the region 18 thereof). Oil fuel (typically a mixture of oil and water is used, e.g. and oil/water emulsion) and/or gas fuel are thus combusted.

Since the injector device is immersed in hot gas and has a flame downstream of it, it undergoes thermal deformations, (i.e. deformations caused by differential temperature induced deformations of different parts thereof). The structure with only connections between the gas supply duct 11 and elongated body 2 via the bridges 13 and between the gas supply duct 11 and oil supply duct 10 via the walls 15 allows thermal induced deformations, with limited internal stresses.

The present invention also refers to a method for manufacturing an injector device. The method comprises:

manufacturing by selective laser melting an injector structure 20 having the features described above, e.g. the elongated body 2, the gas supply duct 11, the oil supply duct 10, the nozzles 7, 8. In addition, the injector structure 20 has first support elements 21 between the oil supply duct 10 and the gas supply duct 11 and a second support element 22 between the gas supply duct 11 and the elongated body 2.

The first support elements 21 are used to support the oil supply duct 10 during manufacturing; for example, the first support elements 21 are defined by a plurality of plates, e.g. extending parallel to one another and perpendicular to the oil supply duct 10 and gas supply duct 11, with one end connected to the oil supply duct 10 and another end connected to the gas supply duct 11.

The second support element 22 is used to support the gas supply duct 11 during manufacturing; for example, the second support element 22 is defined by a plate extending parallel to the gas supply duct 11 and elongated body 2.

Selective laser melting (SLM) is a known technique that comprises providing in succession a plurality of layers of metal dust one on top of the others and for each layer selectively melt by laser and then solidify dust according to a predefined pattern, in order to build an object, such as a component of a gas turbine.

In this connection, the preferred built-up direction is from leading edge to trailing edge to have the nozzles in the best built-up orientation for the best surface quality and the minimum requirement for post-machining.

The method further comprises removing the first support elements and the second support elements.

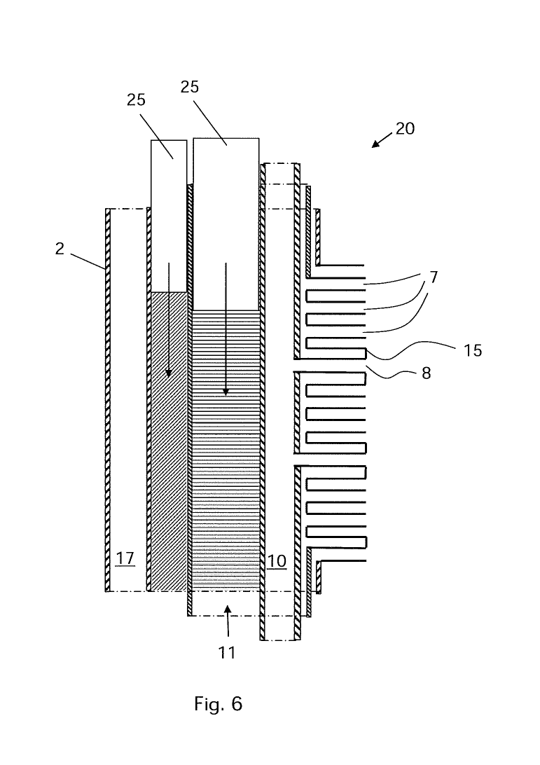

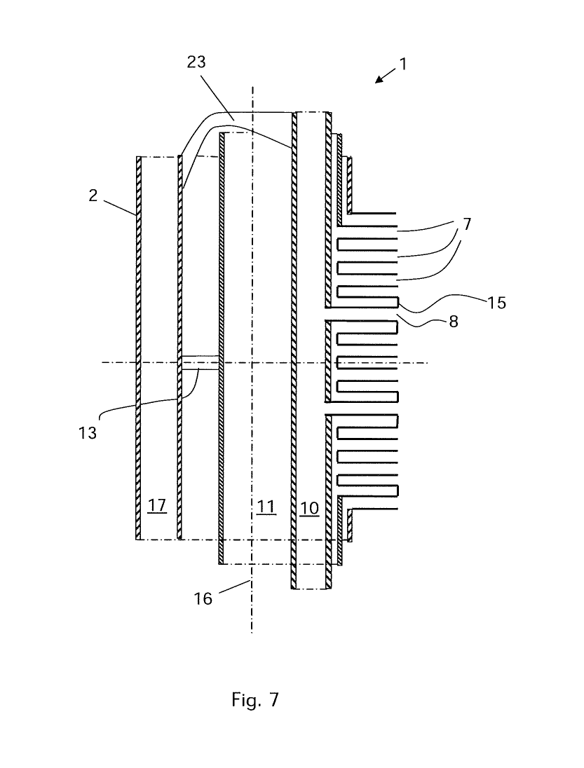

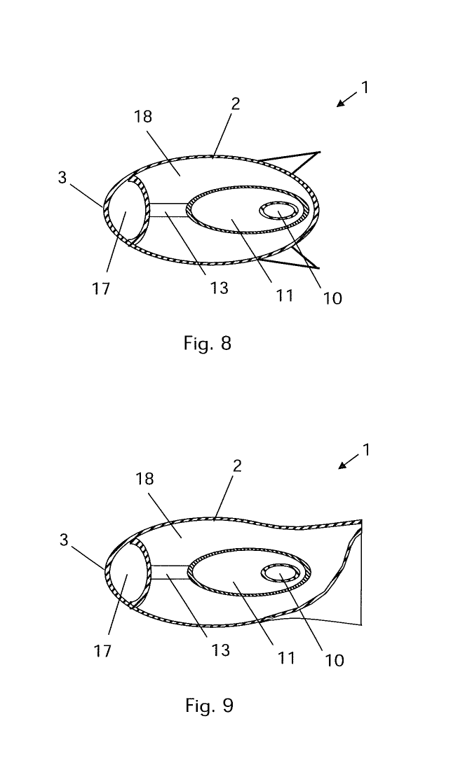

For example, the first support elements 21 can be removed by using a punch and the second support element can be removed by punching or cutting (see FIG. 6 showing punches 25).

In addition, the injector structure 20 can also comprise third support elements 23 between the oil supply duct 10 and the elongated body 2; for example the oil supply duct 10 can extend outside of the gas supply duct 11 and the third support elements can comprise one or more plates provided between the oil supply duct 10 and the elongated body 2. In this case the method further comprises removing the third support elements 23, for example by cutting or punching.

In the above description the first support elements 21, second support element 22 and third support elements 23 have been described as one or more plates. This structure for the support elements 21, 22, 23 is advantageous because it facilitates punching or cutting.

Naturally the features described may be independently provided from one another. For example, the features of each of the attached claims can be applied independently of the features of the other claims.

In practice the materials used and the dimensions can be chosen at will according to requirements and to the state of the art.

### REFERENCE NUMBERS

1 injector device

2 elongated body

3 leading edge

4 trailing edge

6 air nozzles

7 gas nozzles

8 oil nozzles

10 oil supply duct

11 gas supply duct

13 bridge

15 wall

17 channel

18 region of the elongated body 2

20 injector structure

21 first support elements

22 second support element

23 third support elements

25 punch

1. An injector device for a burner of a gas turbine comprising:
an elongated body with a leading edge and a trailing edge;
gas nozzles and oil nozzles;
an oil supply duct housed within the elongated body and connected to the oil nozzles; and
a gas supply duct housed within the elongated body and connected to the gas nozzles;
wherein:
the oil supply duct is connected to the gas supply duct only between at least one oil nozzles and one gas nozzles; and
the gas supply duct is connected to the elongated body only via at least one bridge.

2. The injector device of claim 1, wherein:
a connection between the oil supply duct and the gas supply duct is at a the terminal part of the oil nozzle and gas nozzle.

3. The injector device of claim 1, wherein the elongated body comprises:
at least a channel at the leading edge, wherein the at least one bridge is provided only between the gas supply duct and the channel.

4. The injector device of claim 1, comprising:
only two bridges, each bridge being connected at one side of the gas supply duct.

5. The injector device of claim 1, wherein:
the trailing edge has a lobed configuration or a straight configuration or a zig-zag configuration.

6. The injector device of claim 1, comprising:
air nozzles.

7. The injector device of claim 6, wherein:
the air nozzles and/or gas nozzles and/or oil nozzles are at the trailing edge.

8. The injector device of claim 1, being a selective laser melted (SLM) structure.

9. A method for manufacturing an injector device having:
an elongated body with a leading edge and a trailing edge;
gas nozzles and oil nozzles;
an oil supply duct housed within the elongated body and connected to the oil nozzles; and
a gas supply duct housed within the elongated body and connected to the gas nozzles;
wherein:
the oil supply duct is connected to the gas supply duct only between at least one oil nozzle and one gas; and
the gas supply duct is connected to the elongated body only via at least one bridge, the method comprising:
manufacturing by selective laser melting an injector structure of the injector device the injection structure including at least a first support element between the oil supply duct and the gas supply duct, and at least a second support element between the gas supply duct and the elongated body;
removing the at least a first support element; and
removing the at least a second support element.

10. The method of claim 9, the injector structure includes at least a third support element between the oil supply duct and the elongated body, the method comprising:
removing the at least a third support element.
